(19) United States
(12) Patent Application Publication
(10) Pub. No.: US 2006/0149539 A1
(43) Pub. Date: Jul. 6, 2006

(54) Method for separating a sound frame into sinusoidal components and residual noise

(75) Inventors: Nicolle Hanneke Van Schijndel, Eindhoven (NL); Mireia Gomez Fuentes, Badalona (ES); Richard Heusdens, Alkmaar (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/536,259

(22) PCT Filed: Oct. 29, 2003
(86) PCT No.: PCT/IB03/04871

§ 371 Date: May 24, 2005

(30) Foreign Application Priority Data
Nov. 27, 2002 (EP) 02079940.9

(51) Int. Cl. G10L 19/12

(52) U.S. Cl. 704/222

(57) ABSTRACT

This invention relates to a method of determining (10) a second sound frame (20) representing sinusoidal components and an optionally third sound frame (30) representing a residual from a provided first sound frame, the method includes the steps of: determining a sinusoidal component in the first sound frame among non extracted components; determining an importance measure (40) for the first sound frame; extracting the sinusoidal component from the first sound frame, and incorporating the sinusoidal component in the second sound frame; and repeating said steps until the importance measure fulfils a stop criterion (50). In the method, the step of determining an importance measure for the first sound frame can be executed before said third step or it can be executed between said third and fourth step. Said method further includes the step of: setting the third sound frame to the first sound frame, when the importance measure fulfils said stop criterion. This enables for that only necessarily sinusoidal components are extracted for use in a subsequent compression.

This invention relates to a method of determining a second sound frame representing sinusoidal components and an optionally third sound frame representing a residual from a provided first sound frame.

The present invention also relates to a computer system for performing the method.

The present invention further relates to a computer program product for performing the method.

Additionally, the present invention relates to an arrangement comprising means for carrying out the steps of said method.

U.S. Pat. No. 6,298,322 discloses an encoding and synthesis of tonal audio signals using a dominant and a vector-quantized residual tonal signal. The encoder determines time-varying frequencies, amplitudes, and phases for a restricted number of dominant sinusoid components of the tonal audio signal to form a dominant sinusoid parameter sequence. These (dominant) components are removed from the tonal audio signal to form a residual tonal signal. Said residual tonal signal is encoded using a so-called residual tonal signal encoder (RTSE).

It is common knowledge and knowledge in the above mentioned prior art that in sinusoidal plus residual coding of an audio signal, the audio signal is segmented and each frame is modelled by a sinusoidal part plus a residual part. The sinusoidal part will typically be a sum of sinusoidal components. In most sinusoidal coders the residual is assumed to be a stochastic signal, and can be modelled by noise. When this is the case, the sinusoidal part of the signal should account for all the deterministic (i.e. tonal) components of the original frame.

If the sinusoidal part does not account for all tonal components, some tonal components will be modelled by noise. Because noise is not suitable to model tones, this may introduce artefacts. If the sinusoidal part accounts for more than the deterministic part, sinusoidal components are modelling noise. This is not desirable for two reasons. On the one hand, sinusoids are not suitable to model a noisy signal and artefacts can appear. On the other hand, if these components were modelled by noise, more compression would be achieved.

The state of the art suggests some methods to deal with this issue, i.e., how to obtain a good separation into the sinusoidal and the residual part.
S. N. Levine. Audio Representation for Data Compression and Compressed Domain Processing. Ph.D. Dissertation, Stanford University, 1998.
S. N. Levine, J. O. Smith, “Improvements to the switched parametric & transform audio coder”, in Proc. 1999 IEEE on Applications of Signal Processing to Audio and Acoustics, 1999, pp. 43-46.
S. N. Levine, and J. O. Smith III, “Improvements to the switched parametric & transform audio coder,” in Proc. 1999 IEEE Workshop on Applications of Signal Processing to Audio and Acoustics, New Paltz, New York, Oct. 17-20, 1999, pp. 43-46.
G. Peeters, and X. Rodet, “Signal Characterisation in terms of Sinusoidal and Non-Sinusoidal Components,” in Proc. Digital Audio Effects, Barcelona, Spain, 19-21 November 1998.
X. Rodet, “Musical Sound Signal Analysis/Synthesis: Sinusoidal+Residual and Elementary Waveform Models,” in Proc. IEEE Time-Frequency and Time-Scale Workshop (TFTS '97), University of Warwick, Coventry, UK, 27th-29th Aug. 1997.

Some methods are fully based on the signal properties.
G. Peeters, and X. Rodet, “Signal Characterisation in terms of Sinusoidal and Non-Sinusoidal Components,” in Proc. Digital Audio Effects, Barcelona, Spain, November 1998.
X. Rodet, “Muscial Sound Signal Analysis/Synthesis: Sinusoidal+Residual and Elementary Waveform Models,” in Proc. IEEE Time-Frequency and Time-Scale Workshop (TFTS '97), University of Warwick, Coventry, UK, 27th-29th Aug. 1997.

Others are more based on psychoacoustical considerations.
S. N. Levine. Audio Representation for Data Compression and Compressed Domain Processing. Ph.D. Dissertation, Stanford University, 1998.
S. N. Levine, J. O. Smith, “Improvements to the switched parametric & transform audio coder”, in Proc. 1999 IEEE on Applications of Signal Processing to Audio and Acoustics, 1999, pp. 43-46.
S. N. Levine, and J. O. Smith 11, “Improvements to the switched parametric & transform audio coder,” in Proc. 1999 IEEE Workshop on Applications of Signal Processing to Audio and Acoustics, New Paltz, New York, Oct. 17-20, 1999, pp. 43-46.

Unfortunately, it is not easy to make the separation into the sinusoidal and the residual part and none of these methods give fully satisfactorily results [see, e.g., G. Peeters, and X. Rodet, “Signal Characterisation in terms of Sinusoidal and Non-Sinusoidal Components,” in Proc. Digital Audio Effects, Barcelona, Spain, November 1998]. It is therefore an object of the current invention to have a good separation among the deterministic and the stochastic parts of an input signal in order to avoid artifacts and in order to achieve—in a subsequent compression of the separated signals—an optimal and efficient compression or coding.

Said object is achieved, when the method mentioned in the opening paragraph comprises the steps of:
determining a sinusoidal component in the first sound frame among non extracted components;
determining an importance measure for the first sound frame;
extracting the sinusoidal component from the first sound frame, and incorporating the sinusoidal component in the second sound frame; and
repeating said steps until the importance measure fulfils a stop criterion;

The said method has a number of advantages above existing methods. The extra complexity introduced to the coding stage is almost zero. Moreover, the complexity may even be lowered, because the method indicates—in the last step—when to stop extracting sinusoidal components. As a result, no more sinusoids than necessary are extracted in the third step. In addition, psychoacoustic considerations are easily incorporated. Most importantly, the method gives a good stochastic-deterministic balance, taking into account the nature of the input frame, i.e. the nature of said first sound frame.

In a preferred embodiment of the invention, the second step (of determining an importance measure) can be executed before the third step, or can be executed between the third and fourth step.

In a preferred embodiment of the invention, the method further comprises the step of:
setting the third sound frame to the first sound frame, when the importance measure fulfils said stop criterion.

Hereby, it is achieved also to provide the residual (i.e. the third sound frame) as an input to a subsequent compression of the separated signals, (i.e. the second and third sound frames).

In a preferred embodiment of the invention, said step of extracting the sinusoidal component from the first sound frame, and incorporating the sinusoidal component in the second sound frame further comprises the step of:
removing the sinusoidal component from the first sound frame.

It is hereby an advantage that subsequent determination of sinusoidal components and/or importance measure may be more accurate.

Further alternative embodiments of the invention are reflected in claim 4 through 10.

The invention will be explained more fully below in connection with preferred embodiments and with reference to the drawings, in which:

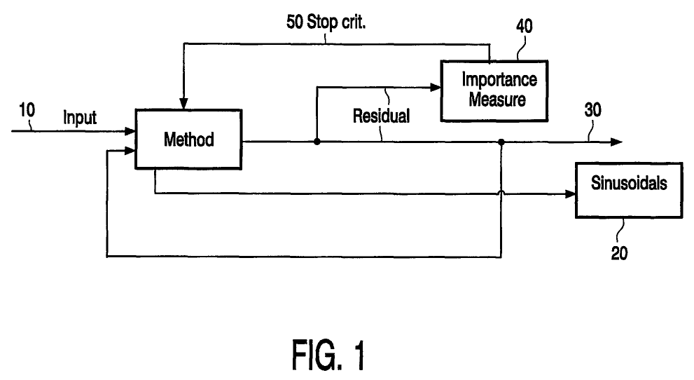

FIG. 1 shows an embodiment of the invention, where a stopping criterion indicates when to stop extracting sinusoidal components in the sinusoidal analysis stage, an extracted component which is introduced into a sinusoidal model and a residual signal;

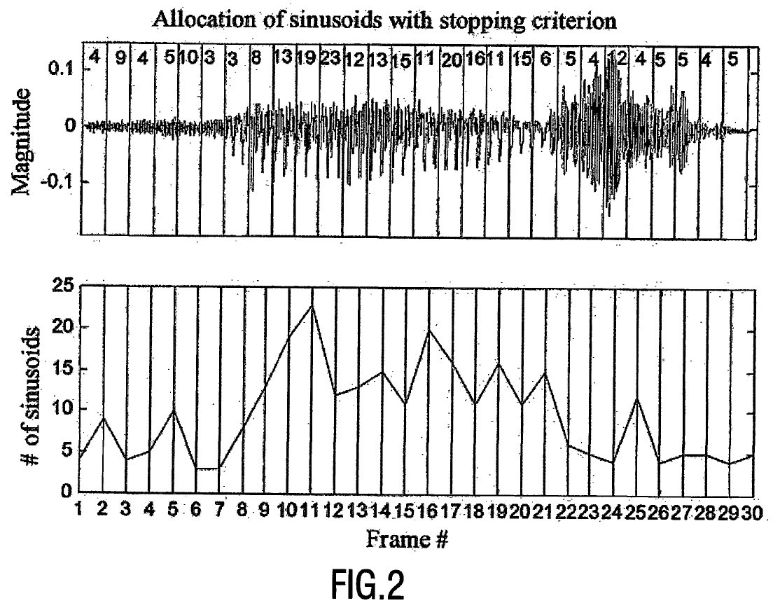

FIG. 2 shows the results of this method for a piece of music (upper panel). The number of sinusoids spent in each frame is indicated in the lower panel;

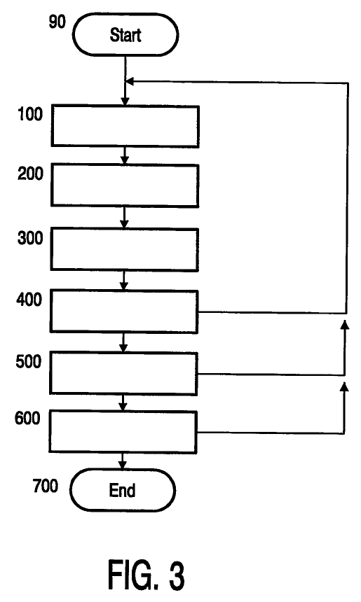

FIG. 3 shows a method of determining a second sound frame representing sinusoidal components and an optionally third sound frame representing a residual from a provided first sound frame; and

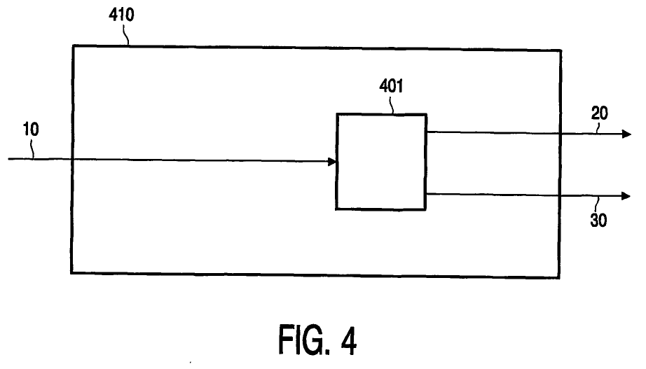

FIG. 4 shows an arrangement for sound processing.

Throughout the drawings, the same reference numerals indicate similar or corresponding features, functions, sound frames, etc.

FIG. 1 shows the introduction of the stopping criterion in the sinusoidal extraction and how an input frame is separated into two different signals: an extracted sinusoidal component which is introduced into a sinusoidal model and a residual signal.

The figure shows an embodiment of the invention, where a low complexity psychoacoustic energy-based stopping criterion is applied in said separation. The figure shows the diagram of blocks of the system. The input frame, reference numeral 10, is input to an extraction method. The extraction method extracts one sinusoidal component in each iteration. After each extraction, two different signals are obtained: the extracted component, which is introduced, i.e. added or appended, into the sinusoidal model, reference numeral 20, and the residual signal, reference numeral 30. Then a psychoacoustic measure or an energy-measure—which will generally and commonly be called importance measure, reference numeral 40 is calculated from the residual signal. From the information provided by said measure, a decision—based on a stop criterion as indicated in reference numeral 50—is made whether there are probably still some important tonal components in it or not. In the last case, the extraction method must be stopped and vice versa.

The measure that gives this information is called Detectability of the residual signal and the Detectability reduction. The Detectability measure is based on the Detectability of the psychoacoustic model presented in S. van de Par, A. Kohlrausch, M. Charestan, R. Heusdens, “A new psychoacoustical masking model for audio coding applications,” in Proc. IEEE Int. Conf. Acoust., Speech and Signal Process., Orlando, USA, May 13-17, 2002.

The value of the Detectability of the residual indicates how much psychoacoustic relevant power is still left in the residual. If it reaches one or a lower value at iteration m, it means that the energy left is inaudible. The detectability reduction indicates how much relevant power has been reduced after one extraction with respect to the power remaining before the extraction. The block ‘importance measure calculation’, reference numeral 40, may compute the Detectability of the residual and its reduction according to the equations:

$${D}_{m} = {\sum }_{f} {R}_{m} ( f ) a ( f ) = {\sum }_{f} \frac{{R}_{m} ( f )}{msk ( f )} \\ \begin{matrix}{reduction}_{Dm} ( m ) = 100 - \frac{100 * {D}_{m}}{{D}_{m - 1}} ( \% ) \\ = 100 ( 1 - \frac{{D}_{m}}{{D}_{m - 1}} ) \\ = 100 ( \frac{Δ D}{{D}_{m - 1}} )\end{matrix} \qquad ( 1 )$$

where Rₘf represents the power spectrum of the residual signal, a(f) the inverse function of msk(f) that is the masking threshold of the input signal (computed in power), f the frequency bins, m the iteration number and AD the decrement of Detectability.

The Detectability indicates whether the energy left is audible, and the value of its reduction gives an indication how to differentiate among the deterministic and the stochastic part of the input frame. The reason is that detectability is usually reduced more when the extracted peak is a tonal component than when it is a noisy component. Then, the extraction algorithm should stop extracting components when either the value of Detectability is equal to or lower than one, or when its reduction reaches a certain value (assumed to correspond to values of reduction when noisy components are extracted).

It may be noted that the introduced measure should only be combined with a psychoacoustic extraction method, for example psychoacoustical matching pursuit presented in R. Heusdens and S. van de Par (2001), “Rate-distortion optimal sinusoidal modelling of audio and speech using psychoacoustical matching pursuits,” in Proc. IEEE Int. Conf. Acoust., Speech and Signal Process., Orlando, USA, May 13-17, 2002. The reason is that if the extraction method does not use psychoacoustics, the measure can give a poor indication. For instance, if the extraction method is an energy-based extraction method without psychoacoustic considerations (like ordinary matching pursuit), the peak that most reduces the energy will be subtracted at each iteration. If this is the case, the energy reduction may be high, while the Detectability reduction may be low if the peak is not psychoacoustically important. As a result, the extraction method would be stopped, whereas perceptually-relevant tonal components may still be left in the signal. Then, if the extraction method used does not include psychoacoustics, a variant on the stopping criterion is recommended. In this case, it is recommended to use Energy reduction as an indicator for the deterministic-stochastic balance instead of Detectability reduction.

Unlike the previously mentioned solutions, this solution makes the decision during the extraction. Therefore, the only thing that introduces complexity to the system is the computation of the measure at each iteration, m. However, if the method is combined with a psychoacoustic extraction method, the complexity introduced is negligible, as the masking threshold is already computed by the extraction method.

As an alternative to said measures, i.e. the psychoacoustic measure and the energy-measure as importance measure—discussed so far—other, alternative measures may be considered as the importance measure.

Said psycho-acoustics is another word for auditory perception (=the response of the human auditory system to sound). In the psycho-acoustic measure the human response is taken into account. Thus, the psycho-acoustic measure is an example of an importance measure that incorporates the human response to sound. However, this is a specific embodiment. Of course, it is also possible to make more advanced implementations of auditory perception. In addition, also importance measures without taken into account the human response to sound are useful. An example of such an importance measure is the mentioned energy measure. FIG. 2 shows the results for the stopping criterion applied to a piece of music (upper panel). The number of sinusoids spent in each frame is indicated in the lower panel.

In order to check the usability of the measure to differentiate among the stochastic and the deterministic part of the (input) signal, the stopping criterion of reference numeral 50 was implemented in a sinusoidal coder and tested. The chosen coder was the SiCAS coder (Sinusoidal Coding of Audio and Speech). In its default situation, a fixed number of peaks are extracted at each frame.

The extraction method used is psychoacoustical matching pursuit presented in R. Heusdens and S. van de Par (2001), “Rate-distortion optimal sinusoidal modelling of audio and speech using psychoacoustical matching pursuits,” in Proc. IEEE Int. Conf. Acoust., Speech and Signal Process., Orlando, USA, May 13-17, 2002.

At each iteration, it extracts the most psychoacoustically relevant peak, according to the masking threshold of the input signal. Therefore, the masking threshold in expression (1) does not need to be computed, as it is already computed by the extraction method.

he threshold value of reduction was not set to one unique value. Instead, a range of values was chosen (from 3.5 up 5.5 in steps of 0.25). Then, a group of speech and one audio signal were coded using each of these values. The same signals were also coded with a fixed number of sinusoids per frame (from 12 up to 20) in order to compare both situations.

Informal listening experiments derive the results that are explained in the next section.

To compare the two different situations (with stopping criterion according to the invention and with fixed number of sinusoids) a pair of coded-decoded signals is chosen such that their quality is the same. Then, two results are obtained. Firstly, when using the stopping criterion the allocation of sinusoids is better than in the case when a fixed number (of sinusoids) per frame is extracted. In other words, the allocation of sinusoids gives a better deterministic-stochastic balance. The figure shows how the sinusoids are allocated in one piece of a coded exemplary song, randomly chosen. The tendency that can be seen in the figure is that a higher number of sinusoids are spent where the (input) signal is more harmonic, i.e. in the voiced part in the middle than when it is more noisy, i.e. in the unvoiced parts at the beginning and end.

This better allocation of sinusoids can easily be noticed by listening to the sinusoidal part of the coded signal. Then the voiced parts are clearly audible (so modelled), while the unvoiced part cannot be heard (because they are not modelled by the sinusoidal model).

econdly, the total number of sinusoids used in the whole peace of music is usually reduced and as a result, the bit rate.

When—throughout this application the wording “sound” is mentioned—it is intended to designate human speech, audio, music, tonal and non-tonal components, or coloured and non-coloured noise in any combination, and it may be applied as input to said extraction method and it may also be applied to the method discussed in the following.

FIG. 3 shows a method of determining a second sound frame representing sinusoidal components and an optionally third sound frame representing a residual from a provided first sound frame.

The first sound frame corresponds to the previously mentioned input signal and represents sinusoidals and a residual, the second sound frame represents sinusoidals and the third sound frame represents the residual. The second and third sound frames may initially be empty or may contain content from applying of this method on a previous (first) sound frame.

In step 90, the method is started in accordance with shown embodiments of the invention. Variables, flags, buffers, etc., keeping track of input (first) and outputs (second and third) sound frames, components, importance measures, etc, corresponding to the sound signals being processed are initialised or set to default values. When the method is iterated a second time, only corrupted variables, flags, buffers, etc, are reset to default values.

In step 100, a sinusoidal component in the first sound frame may be determined. Typically said component will represent some important sound information, i.e. it primarily comprises tonal, non-noisy information.

The simplest determination technique (for said component determination) consists of picking the most prominent peaks in the spectrum of the input signal, i.e. of the first sound frame. The original audio signal is multiplied by an analysis window and a Fast Fourier Transformation is computed for each frame:

$${X}_{l} ( k ) = {\sum }_{n = 0}^{N - 1} w ( n ) x ( n + lH ) {ⅇ}^{- j {w}_{k} n} , 1 = 0 , 1 , 2 …$$

where, x(n) is (a frame of) the original audio signal, w(n) the analysis window, wk is the frequency of the k^{th} bin (2πk/N) in radians, N the length of the frame in samples, l the number of the frame and H the time advance of the window.

In the following literature peak-picking methods are described: X. Serra, “A system for sound analysis/transformation/synthesis based on a deterministic plus stochastic decomposition”, Ph.D. Dissertation, Stanford University, 1990,
X. Serra, J. O. Smith, “A system for Sound Analysis/Transformation/Synthesis based on a Deterministic plus Stochastic Decomposition”, SIGNAL PROCESSING V. Theories and Applications, 1990,
M. Goodwin, “ADAPTIVE SIGNAL MODELS. Theory, Algorithms and Audio Applications”, Kluwer Academic Publishers, 1998,
M. Goodwin, “Residual modelling in music analysis-synthesis”, in Proc. IEEE Int. Conf. on Acoustics, Speech, and signal Processing, 1996, pp. 1005-1008,
X. Rodet, “Musical Sound Signal Analysis/Synthesis: Sinusoidal+Residual and Elementary Waveform Models”, Proc. of 2^{nd} IEEE symp. on applications of time-frequency and time-scale methods, 1997. pp. 111-120,
X. Rodet, “Musical Sound Signal Analysis/Synthesis: Sinusoidal+Residual and Elementary Waveform Models”, Proc. of 2^{nd} IEEE symp. on applications of time-frequency and time-scale methods, 1997. pp. 111-120 and G. Peeters, X. Rodet, “Signal Characterization in terms of Sinusoidal and Non-Sinusoidal Components”, Digital Audio Effects, 1998. B. Doval, X. Rodet, “Fundamental frequency estimation and tracking using maximum likelihood”, in Proc. of ICASSP '93, 1993, pp. 221-224.

Another useful determination technique is psychoacoustical matching pursuit presented in R. Heusdens and S. van de Par (2001), “Rate-distortion optimal sinusoidal modelling of audio and speech using psychoacoustical matching pursuits,” in Proc. IEEE Int. Conf. Acoust., Speech and Signal Process., Orlando, USA, May 13-17, 2002. This method iteratively determines that sinusoidal components that is perceptually most relevant.

In step 200, an importance measure may be determined for the first sound frame. The first sound frame is an input to this method, and—as will be further discussed at the end of the method—the method may be applied for sound frames comprising a song or another logically tied together sound content. The importance measure is generally used to make a decision whether a subsequently determined remaining signal or residual, i.e. the first sound frame without eventually determined sinusoidal component(s)—and extracted sinusoidal components in the next steps—does not contain important tonal components or whether there are probably still some important tonal (sinusoidal) components (in said first sound frame) left. In the first case, the method must be stopped, or in the second case the method may be continued.

It is important to note that the first sound frame currently—during iteration of step 100 and 300, especially—may comprise fewer sinusoidal components, since each time in step 100 a sinusoidal component is determined, and subsequently it is removed in step 300 (from the first sound frame).

Said importance measure may be based on auditory perception, i.e., the human response to sound. A possible implementation of such a measure is a psychoacoustic energy level measure that comprises at least one of:

$$detectability , {D}_{m} = {\sum }_{f} {R}_{m} ( f ) a ( f ) = {\sum }_{f} \frac{{R}_{m} ( f )}{msk ( f )}$$

$$\begin{matrix}{reduction}_{Dm} ( m ) = 100 - \frac{100 * {D}_{m}}{{D}_{m - 1}} ( \% ) \\ = 100 ( 1 - \frac{{D}_{m}}{{D}_{m - 1}} ) \\ = 100 ( \frac{Δ D}{{D}_{m - 1}} )\end{matrix}$$

Rₘ(f) is a power spectrum of the first sound frame with possibly removed component(s). a(f) is the inverse function of msk(f), a masking threshold of the first sound frame, but not having component(s) removed from itself, computed in power; f is the frequency bins, m is a current iteration number representing how many times this step and the subsequent steps 300 and 400 are currently performed, m is set to 0 at the start of the iteration(s), and ΔD is the increment of said detectability. Said msk(f), the masking threshold of the first sound frame may be computed prior to the method start, since it considers said first sound frame at a starting point, i.e. at a point where no components are removed from it. Conversely, Rₘ(f), the power spectrum of the first sound frame may lack component(s), since they may be removed during the subsequent step 300; and is currently computed during the method execution, which thereby reflects the current psychoacoustic energy level in the previously mentioned residual.

As an alternative to said perception measure, other more advanced perception measures may alternatively be considered. These advanced perception measures could, for example, take into account temporal characteristics of sound. In addition, importance measures without considering auditory perception are useful.

In step 300, the sinusoidal component may be extracted from the first sound frame, and incorporated into the second sound frame. Several implementations are possible here. In one embodiment, said sinusoidal component is simply extracted from the first sound frame only by means of its parameters (e.g. amplitude, phase, etc), i.e. it is not physically removed, however the method needs in this case to keep track of (e.g. by tagging, a note, etc.) that it (sinusoidal component) was actually extracted in order to avoid extracting the exact same sinusoidal component in the subsequent iteration.

Alternatively or conversely, in the optional step 600 as claimed in “removing (600) the sinusoidal component from the first sound frame”; said sinusoidal component is removed from the first sound frame, i.e. it is in fact physically removed, this however requires more processing power.

In any of these cases, said second sound frame will currently incorporate the extracted sinusoidal component(s). For this reason, it only comprises sinusoidal components.

Said importance measure may fulfil said stop criterion when said detectability is equal to or lower than one. Alternatively, said importance measure may fulfil said stop criterion when said reduction is lower than a predetermined value.

It may be considered during the method execution to switch between from the detectability to the reduction criterion, etc. and vice versa.

In step 400, it may be decided to repeat said steps (100-300) with optionally said step 600 (of actually removing the sinusoidal component from said first sound frame) until the importance measure fulfils said stop criterion. It may be the case that the first sound frame still comprises more sinusoidal components, by an iteration of steps (100-300), (with m as the current iteration number representing how many times this step and the subsequent steps 200 and 300 are currently performed), a new sinusoidal non extracted component may be found in each run through. Consequently, the first sound frame, each time is left with an extracted component less. Optionally as step 600—the first sound frame, each time is left with a physically sinusoidal component less. Further, it will correspondingly affect said importance measure, especially when—as the optionally mentioned step 600—the sinusoidal component is physically removed from said first sound frame

It is worth noting that step 200 of determining an importance measure for the first sound frame may be executed before step 300, or may be executed between step 300 and 400. It is possible since step 200 can be computed independently.

In step 500, as an optional step, the third sound frame may be set to the first sound frame, when the importance measure fulfils one of previously mentioned stop criterions. The first sound frame at this point only comprises non-important components, since the important sinusoidal components were removed in steps 100-400. In other words, the first sound frame at this point comprises residuals representing primarily non-tonal components or tonal components that are assumed to be unimportant. In other words, said third sound frame—as a copy of the remaining first sound frame—may here be understood as the previously mentioned residual or remaining part or signal when all important components, i.e. e.g. peaks, etc—as discussed in step 300—are physically extracted or at least are having a note or tagging indicating that they (important components) do not belong to said third sound frame.

The steps discussed so far can be summarized as in the following:

In the first iteration step, i.e. in step 100, the input frame, i.e. the first sound frame, is put into the method. Then,—a sinusoidal component is determined (according to some criterion, for example, the energy maximum) and extracted from this frame, i.e. still the first sound frame is only considered at this point. This results in a residual signal (the original input frame minus this component). Then, the importance, i.e. said importance measure, of the first sound frame (without eventually extracted sinusoidal component) is determined. If the importance is high enough, i.e. by means of said importance measure, it is not time for stopping now, and another iteration step will be made. The sinusoidal component will be added—in step 300—(i.e. extracted and moved) to said second sound frame. If the importance is not high enough the method will stop. In the next iteration step, the residual (still the first sound frame, but some sinusoidal components may be extracted from it) is put into the method. Again, a sinusoidal component—among non extracted components is determined and extracted. Its importance is determined (by means of said importance measure (on the first sound frame (without eventually extracted sinusoidal component)). If its importance, i.e. one of said importance measures, is high enough, the method will repeat, etc., corresponding to what is expressed in step 400.

So, the first sound frame is equal to the input frame in the first iteration step, and equal to the input frame minus the already extracted components—as a residual—in the other iterations steps. In each iteration step, a new sinusoidal component is extracted. The result is a new residual. This new residual is the third sound frame corresponding to what is optionally executed in step 500. This new residual or the third sound frame is the difference between said first sound frame and the newly extracted sinusoidal component(s), when the method has finalized its task.

The second sound frame is the sum of components that are extracted so far. It therefore represents the sinusoids.

The step 200 where the importance measure was determined, etc may be executed before step 300, or between step 300 and 400.

The steps 100-400 may further be performed for one or more sound frames, i.e. for a new set of said first, second and third sound frames, a new iteration number, etc., are correspondingly applied for each of said sound frames. Correspondingly, the optional steps 500 and 600 may further be applied. E.g. a song may be sub-divided in a number of frames, and by application of the steps 100-500, etc, each of these frames, each initially considered as a first sound frame, will be separated into a corresponding second sound frame representing sinusoidals or tonal components and a corresponding optionally third sound frame representing a residual.

As a consequence, the song will be separated into frames of sinusoidals or tonal components and the residual, respectively. They are then ready to be used in a subsequent compression of the separated frames. Hereby, an optimal and efficient compression or coding of said song (separated in said parts) may then be achieved.

Usually, the method will start all over again as long as the arrangement is powered. Otherwise, the method may terminate in step 400 (or optionally in step 500 or 600); however, when the arrangement is powered again, etc, the method may proceed from step 100.

FIG. 4 shows an arrangement for sound processing. The arrangement may be used to perform the methods discussed in the foregoing figures.

The arrangement is shown by reference numeral 410 and may comprise an input for a sound signal, reference numeral 10, e.g. as said first sound frame. Correspondingly it may further comprise outputs, reference numerals 20 and 30, for the separated said first sound frame into said second and third sound frames. All of said sound frames may be connected to a processor, reference numeral 401. In a typical application, the processor may perform the separation (into sound signals) as discussed in the foregoing figures.

Said sound signal(s) may designate human speech, audio, music, tonal and non-tonal components, or coloured and non-coloured noise in any combination during the processing of them.

The arrangement may be cascade coupled to like or similar arrangements for serial coupling of sound signals. Additionally, or alternatively arrangements may be parallel coupled for parallel processing of sound signals.

A computer readable medium may be magnetic tape, optical disc, digital video disk (DVD), compact disc (CD record-able or CD write-able), mini-disc, hard disk, floppy disk, smart card, PCMCIA card, etc.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of determining a second sound frame representing sinusoidal components and an optionally third sound frame representing a residual from a provided first sound frame, the method comprising the steps of:
determining a sinusoidal component in the first sound frame among non extracted components;
determining an importance measure for the first sound frame;
extracting the sinusoidal component from the first sound frame, and incorporating the sinusoidal component in the second sound frame; and
repeating said steps until the importance measure fulfils a stop criterion;
wherein the step of determining an importance measure for the first sound frame is executed before step 300, or is executed between step 300 and 400.

2. A method according to claim 1, characterized in that the method further comprises the step of:
setting the third sound frame to the first sound frame, when the importance measure fulfils said stop criterion.

3. A method according to claim 1, characterized in that the step of extracting the sinusoidal component from the first sound frame, and incorporating the sinusoidal component in the second sound frame further comprises the step of:
removing the sinusoidal component from the first sound frame.

4. A method according to claim 1, characterized in that the importance measure is an energy measure.

5. A method according to claim 1, characterized in that the importance measure takes into account psycho-acoustical information, such as a human response to sound.

6. A method according to claim 1, characterized in that importance measure fulfils said stop criterion when a perception measure considers the first sound frame as being unimportant, and wherein said perception measure represents an ear's perception of sound.

7. A method according to claim 1, characterized in that the importance measure is a psychoacoustic energy level measure comprising at least one of:
$$detectability , {D}_{m} = {\sum }_{f} {R}_{m} ( f ) a ( f ) = {\sum }_{f} \frac{{R}_{m} ( f )}{msk ( f )} , \\ \begin{matrix}{reduction}_{Dm} ( m ) = 100 - \frac{100 * {D}_{m}}{{D}_{m - 1}} ( \% ) \\ = 100 ( 1 - \frac{{D}_{m}}{{D}_{m - 1}} ) \\ = 100 ( \frac{Δ D}{{D}_{m - 1}} )\end{matrix}$$
wherein Rₘ(f) is a power spectrum of the first sound frame with possibly removed component(s), a(f) is the inverse function of msk(f), a masking threshold of the first sound frame computed in power, f the frequency bins, m is a current iteration number representing how many times the steps 100-300 are currently performed, m is set to 0 at start of the iterations, and ΔD is the increment of said detectability.

8. A method according to claim 1 characterized in that importance measure fulfils said stop criterion when said detectability is equal to or lower than one.

9. A method according to claim 1 characterized in that importance measure fulfils said stop criterion when said reduction is lower than a predetermined value.

10. A method according to claim 1, characterized in that said steps with optionally steps 500 and 600 are further performed for at least one more sound frame, wherein a new set of said first, second and third sound frames is correspondingly applied and generated.

11. A computer system for performing the method according to claim 1.

12. A computer program product comprising program code means stored on a computer readable medium for performing the method of claim 1 when the computer program is run on a computer.

13. An arrangement comprising means for carrying out the steps of said method.
